(19) United States
(12) Patent Application Publication
(10) Pub. No.: US 2023/0119425 A1
(43) Pub. Date: Apr. 20, 2023

(54) NAVIGATION DEVICE, NAVIGATION SYSTEM, NAVIGATION METHOD, AND STORAGE MEDIUM STORING NAVIGATION PROGRAM

(71) Applicant: TOYOTA JIDOSHA KABUSHIKI KAISHA, Toyota-shi (JP)

(72) Inventors: Kazumi YAMADA, Toyota-shi (JP); Ryo ENDO, Aichi-gun (JP); Hiroshi HATTORI, Toyota-shi (JP); Masatoshi ISHINO, Miyoshi-shi (JP); Jun IWAMOTO, Nisshin-shi (JP)

(73) Assignee: TOYOTA JIDOSHA KABUSHIKI KAISHA, Toyota-shi (JP)

(21) Appl. No.: 17/953,606

(22) Filed: Sep. 27, 2022

(30) Foreign Application Priority Data
Oct. 19, 2021 (JP) 2021-171008

(51) Int. Cl. G01C 21/36; G01C 21/34

(52) U.S. Cl. CPC G01C 21/3623; G01C 21/343

(57) ABSTRACT

A navigation device includes a processor. The processor collects captured images that have been captured by an imaging device mounted at a vehicle, sets a destination, and determines a route to the destination based on the captured images that have been collected.

### CROSS-REFERENCE TO RELATED APPLICATION

This application is based on and claims priority under 35 USC 119 from Japanese Patent Application No. 2021-171008 filed on Oct. 19, 2021, the disclosure of which is incorporated by reference herein.

### BACKGROUND

### Technical Field

The present disclosure relates to a navigation device, a navigation system, a navigation method, and a storage medium storing a navigation program.

### Related Art

Japanese Patent Application Laid-open (JP-A) No. 2008-039501 discloses an automotive navigation device which, when an obstacle existing on a driving route is identified, can indicate the best avoidance measure to the user.

The automotive navigation device disclosed in JP-A No. 2008-039501 covers only real-time hazard prediction and cannot know in advance lists and recommended locations on driving routes and trends in road conditions.

### SUMMARY

The present disclosure has been devised in consideration of the above circumstances, and it is an object thereof to provide a navigation device that can know in advance lists and recommended locations on driving routes and trends in road conditions, a navigation system, a navigation method, and a storage medium storing a navigation program.

A navigation device of a first aspect includes a collection section that collects captured images that have been captured by an imaging device mounted at a vehicle, a setting section that sets a destination, and a determination section that determines a route to the destination based on the captured images that have been collected.

In the navigation device of the first aspect, the collection section collects the captured images that have been captured by the imaging device mounted at the vehicle, the setting section sets a destination, and the determination section determines a route to the destination based on the captured images that have been collected. According to this navigation device, lists and recommended locations on driving routes and trends in road conditions can be known in advance.

A navigation device of a second aspect is the navigation device of the first aspect, wherein the collection section collects operation information pertaining to the vehicle, which corresponds to the captured images that have been captured, and the determination section determines a route to the destination based on the captured images and the operation information which have been collected.

Here, the operation information includes data pertaining to physical quantities such as speed, acceleration, and steering angle that have been detected in the vehicle and information about states such as sudden starts, sudden braking, and abrupt steering that have been determined based on the physical quantities. According to the navigation device of the second aspect, compared to a case where a route to the destination is determined based on only the captured images, lists and recommended locations on driving routes and trends in road conditions can be predicted with higher precision.

A navigation device of a third aspect is the navigation device of the first or second aspect, wherein the determination section selects locations to avoid, which may impede driving of the vehicle, and determines a route that avoids the locations to avoid.

According to the navigation device of the third aspect, a route that avoids locations to avoid can be known in advance.

A navigation device of a fourth aspect is the navigation device of any one of the first to third aspects, wherein the determination section selects a recommended location, to which it is recommended to drive the vehicle, and determines a route via the recommended location.

According to the navigation device of the fourth aspect, a route via a recommended location can be known in advance.

A navigation system of a fifth aspect includes the navigation device of any one of the first to fourth aspects and a plurality of vehicles that are connected by communication to the navigation device.

According to the navigation system of the fifth aspect, compared to a case where a route to a destination is determined based on captured images that have been collected from one vehicle, lists and recommended locations on driving routes and trends in road conditions can be predicted with higher precision.

A navigation method of a sixth aspect is a navigation method, comprising, by a computer collecting captured images that have been captured by an imaging device mounted at a vehicle, setting a destination, and determining a route to the destination based on the captured images that have been collected.

According to the navigation method of the sixth aspect, lists and recommended locations on driving routes and trends in road conditions can be known in advance.

A non-transitory storage medium storing a navigation program of a seventh aspect is executable by a computer to perform processing to collect captured images that have been captured by an imaging device mounted at a vehicle, set a destination, and determine a route to the destination based on the captured images that have been collected.

According to the navigation program of the seventh aspect, lists and recommended locations on driving routes and trends in road conditions can be known in advance.

According to the present disclosure, lists and recommended locations on driving routes and trends in road conditions can be known in advance.

### BRIEF DESCRIPTION OF THE DRAWINGS

Exemplary embodiments of the present disclosure will be described in detail based on the following figures, wherein:

FIG. 1 is a diagram illustrating the schematic configuration of a navigation system according to a first embodiment;

FIG. 2 is a block diagram illustrating hardware configurations of a vehicle of the first embodiment;

FIG. 3 is a block diagram illustrating functional configurations of an on-board unit of the first embodiment;

FIG. 4 is a block diagram illustrating hardware configurations of a center server of the first embodiment;

FIG. 5 is a block diagram illustrating functional configurations of the center server of the first embodiment;

FIG. 6 is a sequence diagram illustrating a flow of processes in the navigation system of the first embodiment;

FIG. 7 is a front view illustrating an example of a destination candidate screen according to the first embodiment;

FIG. 8 is a front view illustrating an example of an impediment choosing screen according to the first embodiment;

FIG. 9 is a front view illustrating an example of a route determination screen according to the first embodiment;

FIG. 10 is a sequence diagram illustrating a flow of processes in a navigation system of a second embodiment;

FIG. 11 is a front view illustrating an example of a merit choosing screen according to the second embodiment; and

FIG. 12 is a sequence diagram illustrating a flow of processes in a navigation system of a third embodiment.

### DETAILED DESCRIPTION

### First Embodiment

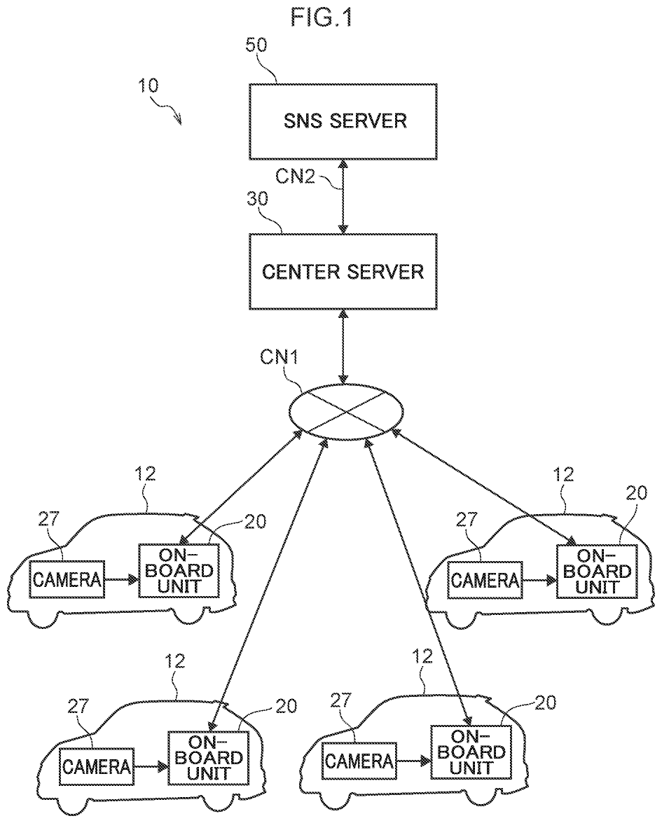

As shown in FIG. 1, a navigation system 10 of a first embodiment is configured to include plural vehicles 12, a center server 30, and a social networking service (SNS) server 50. In each vehicle 12 are mounted an on-board unit 20 and a camera 27. The camera 27 is an example of an imaging device, and the center server 30 is an example of a navigation device.

The on-board units 20 of the vehicles 12 and the center server 30 are connected to each other via a network CN1. Furthermore, the center server 30 and the SNS server 50 are connected to each other via a network CN2. It will be noted that the center server 30 and the SNS server 50 may also be connected through the network CN1.

(Vehicles)

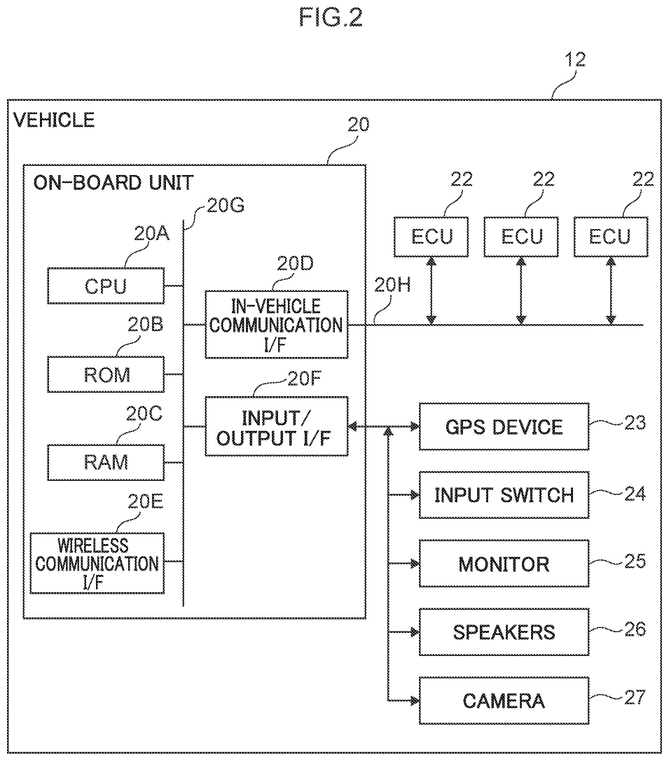

As shown in FIG. 2, each vehicle 12 according to the present embodiment is configured to include the on-board unit 20, plural ECUs 22, a Global Positioning System (GPS) device 23, an input switch 24 serving as an operation input device, a monitor 25 serving as a display device, speakers 26, and the camera 27.

The on-board unit 20 is configured to include a central processing unit (CPU) 20A, a read-only memory (ROM) 20B, a random-access memory (RAM) 20C, an in-vehicle communication interface (I/F) 20D, a wireless communication I/F 20E, and an input/output I/F 20F. The CPU 20A, the ROM 20B, the RAM 20C, the in-vehicle communication I/F 20D, the wireless communication I/F 20E, and the input/output I/F 20F are communicably connected to each other via an internal bus 20G.

The CPU 20A is a central arithmetic processing unit, executes various types of programs, and controls each part of the on-board unit 20. That is, the CPU 20A reads programs from the ROM 20B and executes the programs using the RAM 20C as a workspace.

The ROM 20B stores various types of programs and various types of data. In the ROM 20B of the present embodiment is stored a control program for controlling the on-board unit 20.

The RAM 20C temporarily stores programs or data as a workspace.

The in-vehicle communication I/F 20D is an interface for connecting to the ECUs 22. The interface uses the CAN communication protocol. The in-vehicle communication I/F 20D is connected to an external bus 20H. The plural ECUs 22 are provided for each function in the vehicle 12. Examples of the ECUs 22 of the present embodiment include a vehicle control ECU, an engine ECU, a brake ECU, a body ECU, a camera ECU, and a multimedia ECU.

The wireless communication I/F 20E is a wireless communication module for communicating with the center server 30. The wireless communication module uses a communication protocol such as 5G, LTE, or Wi-Fi (registered trademark), for example. The wireless communication I/F 20E is connected to the network CN1.

The input/output I/F 20F is an interface for communicating with the GPS device 23, the input switch 24, the monitor 25, the speakers 26, and the camera 27. It will be noted that the GPS device 23, the input switch 24, the monitor 25, the speakers 26, and the camera 27 may also be connected to the on-board unit 20 via the ECUs 22.

The GPS device 23 is a device that calculates the current position of the vehicle 12. The GPS device 23 includes an antenna (not shown in the drawings) that receives signals from GPS satellites.

The input switch 24 is configured as a touch panel doubling as the monitor 25. It will be noted that the input switch 24 may also be a switch that is provided in the instrument panel, center console, or steering wheel and inputs operations performed by the fingers of an occupant. As the input switch 24 in this case, for example, a push-button numeric keypad or a touchpad can be employed.

The monitor 25 is provided in the instrument panel or the meter panel, for example, and is a liquid crystal monitor for displaying images according to the current location, the driving route, and advisory information. As described above, the monitor 25 is provided as a touch panel doubling as the input switch 24.

The speakers 26 are provided in the instrument panel, the center console, the front pillars, and/or the dashboard, for example, and are devices for outputting audio according to advisory information and the like.

The camera 27 is an imaging device for capturing images outside the vehicle. The camera 27 may be provided outside the vehicle or inside the vehicle.

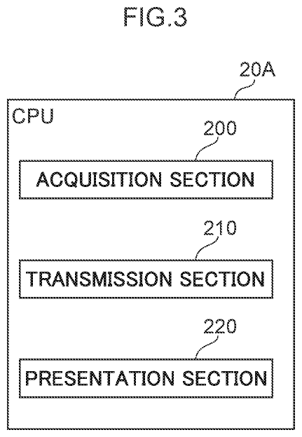

In the on-board unit 20 of the present embodiment, the CPU 20A functions as an acquisition section 200, a transmission section 210, and a presentation section 220 shown in FIG. 3 by executing the control program.

The acquisition section 200 has the function of acquiring captured images that have been captured by the camera 27. The acquisition section 200 also acquires from the GPS device 23 the current position of the vehicle 12, which corresponds to the captured images that have been captured. The acquisition section 200 also acquires from the ECUs 22 operation information according to the vehicle 12, which corresponds to the captured images that have been captured. It will be noted that the operation information includes data according to physical quantities such as speed, acceleration, and steering angle that have been detected in the vehicle 12 and information about states such as sudden starts, sudden braking, and abrupt steering that have been determined based on the physical quantities.

The transmission section 210 has the function of sending to the center server 30 road information to which has been added the captured images, the operation information according to the vehicle 12, which corresponds to the captured images, and the position information according to the vehicle 12. Furthermore, in a case where an instruction to have the center server 30 determine a route to a destination (hereinafter called a “route determination instruction”) has been received from the occupant, the transmission section 210 sends the route determination instruction to the center server 30.

The presentation section 220 has the function of presenting to the occupant via the monitor 25 destination candidates set by the center server 30 described later. The presentation section 220 also presents to the occupant via the monitor 25 impediments collected by the center server 30 described later. The presentation section 220 also presents to the occupant via the monitor 25 the route to the destination determined by the center server 30 described later. It will be noted that the presentation section 220 may also present to the occupant via the speakers 26 at least any one of the destination candidates, the impediments, and the route to the destination.

(SNS Server)

The SNS server 50 has functions as a management server that manages a social networking service (hereinafter simply called an “SNS”). In the SNS server 50 are stored data according to contributions for each user account. Below, a case where the users of the SNS server 50 are the occupants of the vehicles 12 will be described as an example.

(Center Server)

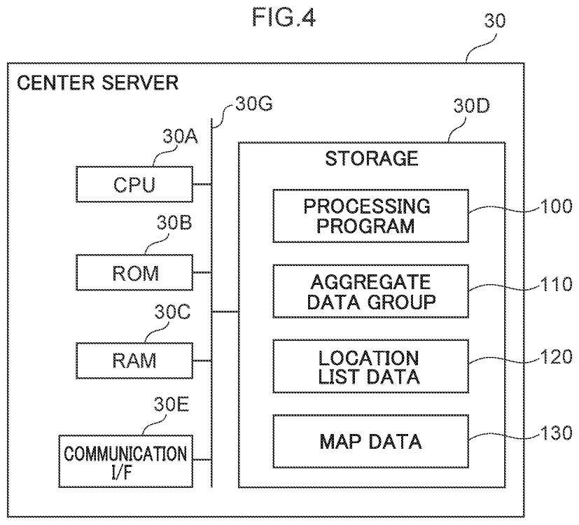

As shown in FIG. 4, the center server 30 is configured to include a CPU 30A, a ROM 30B, a RAM 30C, a storage 30D, and a communication I/F 30E. The CPU 30A, the ROM 30B, the RAM 30C, the storage 30D, and the communication I/F 30E are communicably connected to each other via an internal bus 30G. The CPU 30A is an example of a processor. The functions of the CPU 30A, the ROM 30B, the RAM 30C, and the communication I/F 30E are the same as those of the CPU 20A, the ROM 20B, the RAM 20C, and the wireless communication I/F 20E of the on-board unit 20.

The storage 30D is configured by a hard disk drive (HDD) or a solid-state drive (SSD) and stores various types of programs and various types of data.

The CPU 30A reads programs from the storage 30D and executes the programs using the RAM 30C as a workspace.

In the storage 30D of the present embodiment are stored a processing program 100, an aggregate data group 110, location list data 120, and map data 130. The processing program 100 is a program for realizing the various functions that the center server 30 has, and is an example of a navigation program.

In the aggregate data group 110 is stored the road information to which has been added the captured images received from the on-board units 20, the operation information according to the vehicles 12, which corresponds to the captured images, and the position information according to the vehicles 12.

In the location list data 120, locations on maps are stored together with genres of those locations as a location list. The genres are information giving overviews of those locations, such as “the ocean,” “parks,” “historical structures,” and “mountains,” for example. It will be noted that the location list data 120 may also be acquired via the network CN1.

The map data 130 are plural map data for each regional division or each road division.

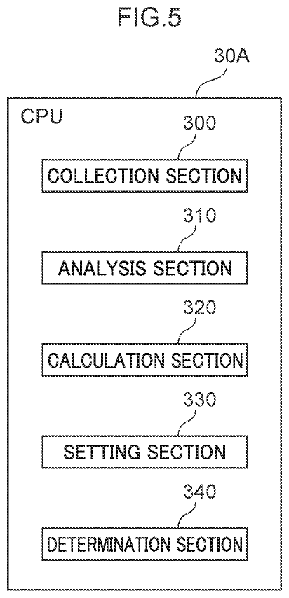

In the center server 30 of the present embodiment, the CPU 30A functions as a collection section 300, an analysis section 310, a calculation section 320, a setting section 330, and a determination section 340 shown in FIG. 5 by executing the processing program 100.

The collection section 300 has the function of collecting the captured images sent from the vehicles 12. The collection section 300 also collects the operation information according to the vehicles 12, which corresponds to the captured images and the position information according to the vehicles 12.

The collection section 300 also collects histories of contributions made to the SNS by the occupants of the vehicles 12 that have instructed the center server 30 to determine routes (hereinafter also called “contribution histories”). In the present embodiment, as the contribution histories, for example, text information that is character data, image information that is still image and moving image data, and audio information that is sound data are applied. It will be noted that, as the contribution histories, comments or evaluations with respect to contributions of specific users may also be applied. Furthermore, the collection section 300 may also collect Web (World Wide Web) page browsing histories stored in, for example, mobile devices carried by the occupants of the vehicles 12.

The analysis section 310 analyzes, based on the captured images collected by the collection section 300, impediments that may arise during driving of the vehicles 12 at the positions of the vehicles 12, which correspond to the captured images. Below, impediments that may arise during driving of the vehicles 12 are also simply called “impediments.” In the present embodiment, the analysis section 310 analyzes, based on the captured images and the operation information collected by the collection section 300, impediments that may arise during driving of the vehicles 12 at the positions of the vehicles 12 corresponding to the captured images. For example, in a case in which the collection 300 has collected a captured image in which an animal appears in front of a vehicle 12 and has collected the occurrence of sudden braking as the operation information corresponding to the captured image, the analysis section 310 analyzes that the impediment is an “impact with an animal.”

The calculation section 320 calculates popularity ratings of each location. In the present embodiment, the calculation section 320 calculates the popularity ratings in such a way that the greater the number of times that a location has been set as a destination by the setting section 330 described later, the higher the popularity rating of the corresponding location. However, the calculation section 320 is not limited to this example. For example, the calculation section 320 may also calculate the popularity ratings in such a way that the greater the number of times that contributions about a location have been made to the SNS, the higher the popularity rating of the corresponding location.

The calculation section 320 also analyzes frequencies of appearance by genre from the contribution histories collected by the collection section 300 and calculates preference scores. For example, in a case in which the contributions of an occupant include many pictures of the ocean, the calculation section 320 calculates the preference score so that the percentage for the “ocean” genre becomes higher. Furthermore, for example, in a case in which there are many pictures of children, the calculation section 320 may calculate the preference score so that the percentage for the “parks” genre becomes higher.

It will be noted that the calculation section 320 may also derive the preference scores from contribution histories of users other than the occupants. For example, the calculation section 320 may also calculate the preference scores using all users of the SNS, users having ties to the occupants, or users of groups to which the occupants belong. This allows the calculation section 320 to convert trends to preference scores. Furthermore, the calculation section 320 may also calculate the preference scores from, for example, Web page browsing histories stored in, for example, mobile devices carried by the occupants.

The setting section 330 has the function of setting a destination. In the present embodiment, the setting section 330 reads the location list stored in the location list data 120 and sets, as destination candidates, plural locations whose popularity ratings are equal to or greater than a predetermined value and which correspond to a genre whose preference score is the highest. It will be noted that the setting section 330 may also set, as destination candidates, plural locations that correspond to the genre whose preference score is the highest, regardless of their popularity ratings. Furthermore, the setting section 330 may also set, as destination candidates, locations stored as tourist sites in the map data 130. The setting section 330 sets, as the destination, a destination candidate that has been chosen by the occupant from among the destination candidates it has set.

The determination section 340 has the function of determining a route to the destination based on the captured images collected by the collection section 300. It will be noted that in the present embodiment the determination section 340 selects locations to avoid that may impede driving of the vehicle 12 and determines a route that avoids the locations to avoid. Specifically, the determination section 340 receives, from the occupant, a choice of an impediment that the occupant would most like to avoid from among impediments that may arise in routes to the destination. The determination section 340 determines a route that avoids the locations to avoid, which are locations where the received impediment may arise. However, the determination section 340 is not limited to this example. For example, the determination section 340 may also receive, from the occupant, a choice of plural impediments that the occupant would like to avoid from among impediments that may arise on routes to the destination.

(Control Flow)

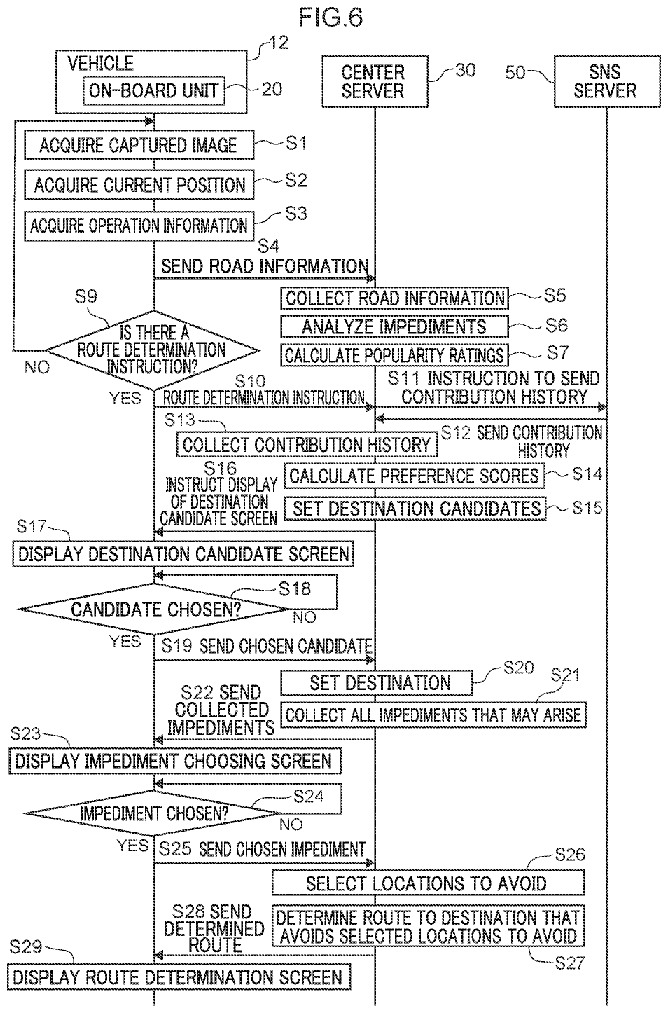

A flow of processes executed in the navigation system 10 of the present embodiment will now be described using the sequence diagram of FIG. 6.

In step S1 of FIG. 6, the on-board unit 20 acquires a captured image captured by the camera 27.

In step S2 the on-board unit 20 acquires from the GPS device 23 the current position of the vehicle 12, which corresponds to the captured image that has been captured.

In step S3 the on-board unit 20 acquires from the ECUs 22 the operation information corresponding to the captured image that has been captured.

In step S4 the on-board unit 20 sends to the center server 30 the road information to which has been added the captured image, the operation information according to the vehicle 12, which corresponds to the captured image, and the position information according to the vehicle 12.

In step S5 the center server 30 collects in the aggregate data group 110 the road information sent from the plural on-board units 20.

In step S6 the center server 30 analyzes, based on the captured images and the operation information it has collected, impediments that may arise during the driving of the vehicle 12 at the position of the vehicle 12, which corresponds to the captured image.

In step S7 the center server 30 calculates the popularity ratings of each location. Specifically, the center server 30 reads the location list data 120 and calculates the popularity ratings in such a way that the greater the number of times that a location has been set as a destination described later, the higher the popularity rating of the corresponding location.

In step S9 the on-board unit 20 determines whether or not it has received a route determination instruction from the occupant via the input switch 24 or the like. In a case where the on-board unit 20 determines that it has received a route determination instruction (step S9: YES), the on-board unit 20 proceeds to step S10. In a case in which the on-board unit 20 determines that it has not received a route determination instruction (step S9: NO), the on-board unit 20 returns to step S1.

In step S10 the on-board unit 20 sends the route determination instruction to the center server 30.

In step S11 the center server 30 sends an instruction to the SNS server 50 to send to the center server 30 the history of contributions made to the SNS by the occupant of the vehicle 12 that has instructed the center server 30 to determine a route.

In step S12 the SNS server 50 sends to the center server 30 the history of contributions made to the SNS by the occupant of the vehicle 12 that has instructed the center server 30 to determine a route.

In step S13 the center server 30 collects the history of contributions made to the SNS by the occupant of the vehicle 12 that has instructed the center server 30 to determine a route.

In step S14 the center server 30 analyzes the frequencies of appearance by genre from the contribution history it has collected and calculates the preference scores. Specifically, the center server 30 analyzes the frequencies of appearance by genre from the contribution history. The center server 30 calculates the preference scores by genre in such a way that the higher the frequency of appearance of a genre, the higher the preference score of that genre.

In step S15 the center server 30 sets destination candidates. Specifically, the center server 30 reads the location list stored in the location list data 120 and sets, as destination candidates, plural locations whose popularity rating is equal to or greater than a predetermined value and which correspond to the genre whose preference score is the highest.

In step S16 the center server 30 sends the destination candidates it has set to the on-board unit 20.

In step S17 the on-board unit 20 displays on the monitor 25 a destination candidate screen that follows a predetermined format.

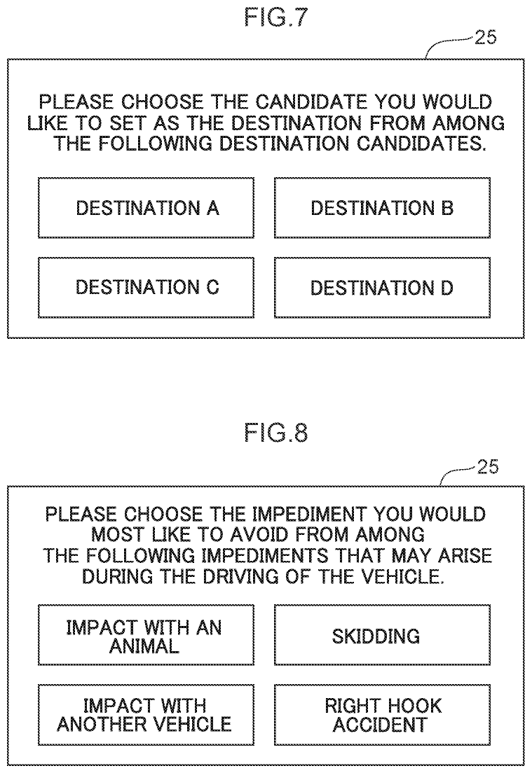

As shown in FIG. 7, in the destination candidate screen according to the present embodiment, a message prompting the occupant to choose a candidate that the occupant would like to set as the destination from among the destination candidates is displayed. In the example shown in FIG. 7, “destination A,” “destination B,” “destination C,” and “destination D” are displayed as the destination candidates in the destination candidate screen.

In step S18 the on-board unit 20 stands by until any of the destination candidates is chosen via the input switch 24 from the destination candidate screen. In a case in which the CPU 20A determines that any of the destination candidates has been chosen (step S18: YES), the on-board unit 20 proceeds to step S19.

In step S19 the on-board unit 20 sends the destination candidate that has been chosen to the center server 30.

In step S20 the center server 30 sets as the destination the destination candidate it has received.

In step S21 the center server 30 collects all impediments that may arise on routes to the destination it has set. Specifically, the center server 30 reads the map data 130 and collects all routes to the destination it has set. The center server 30 also reads the road information from the aggregate data group 110 and collects all impediments that may arise on the routes it has collected.

In step S22 the center server 30 sends all the impediments it has collected to the on-board unit 20.

In step S23 the on-board unit 20 displays on the monitor 25 an impediment choosing screen that follows a predetermined format.

As shown in FIG. 8, in the impediment choosing screen according to the present embodiment, a message prompting the occupant to choose an impediment that the occupant would most like to avoid and all the impediments that may arise on routes to the destination that has been set are displayed. In the example shown in FIG. 8, “impact with an animal,” “skidding,” “rear-end collision with another vehicle,” and “right hook accident” are displayed as impediments that may arise in the impediment choosing screen.

In step S24 the on-board unit 20 stands by until any of the impediments is chosen via the input switch 24 from the impediment choosing screen. In a case in which the on-board unit 20 determines that any of the impediments has been chosen (step S24: YES), the on-board unit 20 proceeds to step S25.

In step S25 the on-board unit 20 sends the impediment that has been chosen to the center server 30.

In step S26 the center server 30 selects locations to avoid that correspond to the impediment it has received.

In step S27 the center server 30 determines a route to the destination that avoids the locations to avoid it has selected.

In step S28 the center server 30 sends the route it has determined to the on-board unit 20.

In step S29 the on-board unit 20 displays on the monitor 25 a route determination screen that follows a predetermined format.

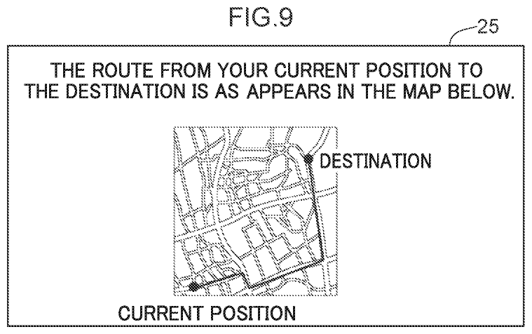

As shown in FIG. 9, in the route determination screen according to the present embodiment, the route from the current position of the vehicle 12 to the destination that has been determined is displayed.

### Summary of First Embodiment

As described above, according to the navigation system 10 of the present embodiment, lists and recommended locations on driving routes and trends in road conditions can be known in advance.

Here, the center server 30 of the present embodiment selects locations to avoid and determines a route that avoids the locations to avoid. Because of this, a route that avoids locations to avoid can be known in advance.

Furthermore, the navigation system 10 of the present embodiment includes the center server 30 and the plural vehicles 12 that are connected by communication to the center server 30. Because of this, compared to a case where a route to a destination is determined based on captured images that have been collected from one vehicle, lists and recommended locations on driving routes and trends in road conditions can be predicted with higher precision.

### Second Embodiment

In the first embodiment, the center server 30 determined a route to the destination that avoided locations to avoid. In a second embodiment, the center server 30 determines a route to the destination via a recommended location, to which it is recommended to drive the vehicle 12. Below, differences from the first embodiment will be described. It will be noted that hardware configurations are the same as those of the first embodiment, so description will be omitted.

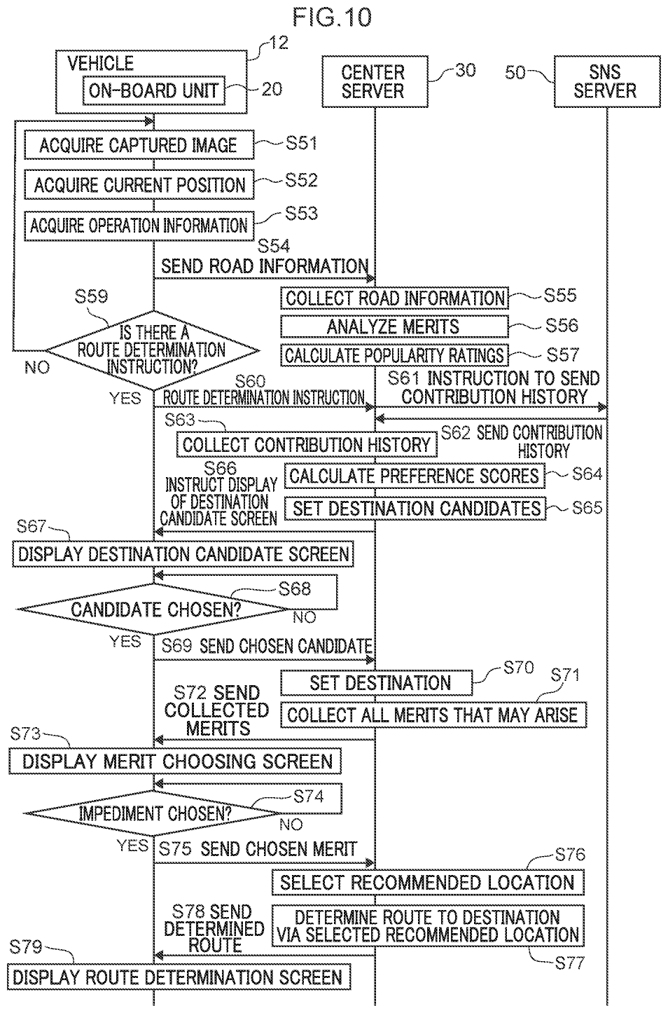

A flow of processes in the navigation system 10 of the present embodiment will now be described using FIG. 10. It will be noted that step S51 to step S55 of FIG. 10 are the same processes as those of step S1 to step S5 of FIG. 6, so description will be omitted.

In step S56 of FIG. 10, the center server 30 analyzes, based on the captured image and the operation information it has collected, merits that may arise during the driving of the vehicle 12 at the position of the vehicle 12, which corresponds to the captured image. It will be noted that the center server 30 may also analyze, based on the captured image or the operation information it has collected, merits that may arise during the driving of the vehicle 12 at the position of the vehicle 12, which corresponds to the captured image. Below, merits that may arise during the driving of the vehicle 12 will also simply be called “merits.” For example, in a case in which where the center server 30 has collected a captured image in which another vehicle 12 does not appear in front of the vehicle 12 and has collected a vehicle speed of 40 km/h or higher as the operation information corresponding to the captured image, the analysis section 310 analyzes that there is the merit of “being able to drive smoothly.”

Furthermore, step S57 to step S70 of FIG. 10 are the same processes as those of step S7 to step S20 of FIG. 6, so description will be omitted.

In step S71 the center server 30 collects all merits that may arise on routes to the destination it has set. Specifically, the center server 30 reads the map data 130 and collects all routes to the destination it has set. The center server 30 also reads the road information from the aggregate data group 110 and collects all merits that may arise on the routes it has collected.

In step S72 the center server 30 sends the merits it has collected to the on-board unit 20.

In step S73 the on-board unit 20 displays on the monitor 25 a merit choosing screen that follows a predetermined format.

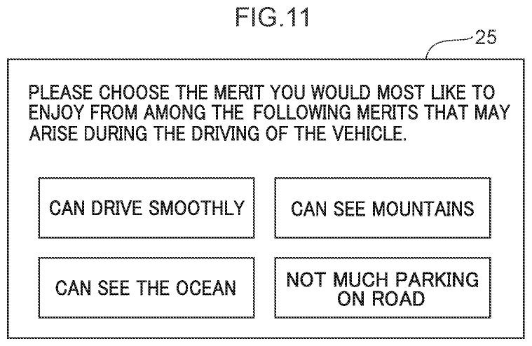

As shown in FIG. 11, in the merit choosing screen according to the present embodiment, a message prompting the occupant to choose a merit that the occupant would most like to enjoy and all the merits that may arise on routes to the destination that has been set are displayed. In the example shown in FIG. 11, “can drive smoothly,” “can see mountains,” “can see the ocean,” and “not much parking on road” are displayed as merits that may arise in the merit choosing screen.

In step S74 the on-board unit 20 stands by until any of the merits is chosen via the input switch 24 from the merit choosing screen. In a case in which the on-board unit 20 determines that any of the merits has been chosen (step S74: YES), the on-board unit 20 proceeds to step S75.

In step S75 the on-board unit 20 sends the merit that has been chosen to the center server 30.

In step S76 the center server 30 selects a location, to which the merit it has received may arise, in other words, a recommended location, to which it is recommended to drive the vehicle 12.

In step S77 the center server 30 determines a route to the destination via the recommended location it has selected.

Step S78 and step S79 of FIG. 10 are the same processes as step S28 and step S29 of FIG. 6, so description will be omitted.

It will be noted that in a case in which it is detected that the occupant is not feeling well or a case in which a predetermined amount of time (e.g., two hours) has elapsed since the vehicle 12 departed, the center server 30 may select a new recommended location, such as a restaurant or a convenience store, and determine a route via that new recommended location it has selected even if the vehicle 12 is already driving toward the destination.

### Third Embodiment

In the first embodiment, the center server 30 analyzed, based on the captured image and the operation information, impediments that may arise during the driving of the vehicle 12 at the position of the vehicle 12, which corresponds to the captured image. In a third embodiment, the on-board unit 20 analyzes, based on the captured image and the operation information, impediments that may arise during the driving of the vehicle 12 at the position of the vehicle 12, which corresponds to the captured image. Below, differences from the first embodiment will be described. It will be noted that hardware configurations are the same as those of the first embodiment, so description will be omitted.

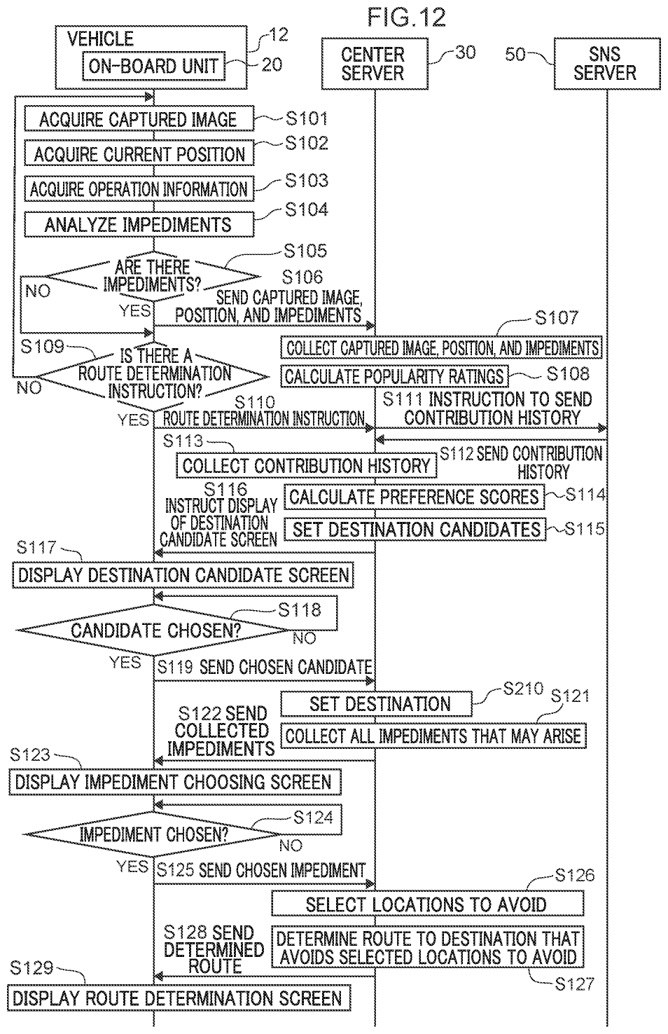

A flow of processes in the navigation system 10 of the present embodiment will now be described using FIG. 12. It will be noted that step S101 to step S103 of FIG. 12 are the same processes as those of step S1 to step S3 of FIG. 6, so description will be omitted.

In step S104 of FIG. 12, the on-board unit 20 analyzes, based on the captured image and the operation information, impediments that may arise during the driving of the vehicle 12 at the position of the vehicle 12, which corresponds to the captured image.

In step S105 the on-board unit 20 determines, from the analysis result in step S104, whether or not impediments may arise at the position of the vehicle 12, which corresponds to the captured image that has been captured. In a case in which the on-board unit 20 determines from the analysis result that impediments may arise (step S105: YES), the on-board unit 20 proceeds to step S106. In a case in which the on-board unit 20 determines from the analysis result that impediments may not arise (step S105: NO), the on-board unit 20 proceeds to step S109.

In step S106 the on-board unit 20 sends to the center server 30 the captured image, the position of the vehicle 12, which corresponds to the captured image, and the impediments it has analyzed.

In step S107 the center server 30 collects in the aggregate data group 110 the captured images sent from the plural on-board units 20, the positions of the vehicles 12, which corresponds to the captured images, and the analyzed impediments.

Step S108 to step S129 of FIG. 12 are the same processes as those of step S7 to step S29 of FIG. 6, so description will be omitted.

[Remarks]

The center server 30 of the above embodiments set destination candidates based on the history of contributions made by the occupant of the vehicle 12 to the SNS. However, the center server 30 is not limited to this. For example, the center server 30 may also acquire from the occupant beforehand the purpose for which the occupant has gotten into the vehicle 12 (e.g., work, recreation, etc.) and set destination candidates in accordance with that purpose. Furthermore, the center server 30 may also set destination candidates in accordance with the type of the vehicle 12. For example, in a case in which the vehicle 12 is a family car, there is the potential for children to be riding in it, so the center server 30 may set an amusement park as a destination candidate. Furthermore, in a case in which the vehicle 12 is a motorcycle, it may be assumed that the vehicle 12 will not drive a long distance, so the center server 30 may set, as a destination candidate, a supermarket less than a predetermined distance (e.g., 5 km) from the current position of the vehicle 12. Alternatively, the center server 30 may also select locations to avoid or recommended locations in accordance with the type of the vehicle 12.

It will be noted that the various types of processes that the CPUs 20A and 30A executed by reading software (programs) in the above embodiments may also be executed by various types of processors other than CPUs. Examples of processors in this case include programmable logic devices (PLDs) whose circuit configuration can be changed after manufacture, such as field-programmable gate arrays (FPGAs), and dedicated electrical circuits that are processors having a circuit configuration dedicatedly designed for executing specific processes, such as application-specific integrated circuits (ASICs). Furthermore, each of the various types of processes above may be executed by one of these various types of processors or may be executed by a combination of two or more processors of the same type or different types (e.g., plural FPGAs, and a combination of a CPU and an FPGA, etc.). Furthermore, the hardware structures of these various types of processors are more specifically electrical circuits in which circuit elements such as semiconductor elements are combined.

Furthermore, in the above embodiments, the processing program 100 was described as being stored (installed) beforehand in the storage 30D, but the processing program 100 is not limited to this. The program may also be provided in a form in which it is stored in a non-transitory storage medium such as a compact disc read-only memory (CD-ROM), a digital versatile disc read-only memory (DVD-ROM), and a universal serial bus (USB) memory. Furthermore, the program may also take a form in which it is downloaded via a network from an external device.

The flows of processes described in the above embodiments are also examples, and unnecessary steps may be omitted, new steps may be added, and process orders may be changed in a range that does not depart from the spirit thereof.

In addition, the configurations of the vehicle 12, the center server 30, and the SNS server 50 described in the above embodiments are examples and may also be changed depending on the situation in a range that does not depart from the spirit thereof

What is claimed is:

1. A navigation device comprising a processor, wherein the processor:
collects captured images that have been captured by an imaging device mounted at a vehicle,
sets a destination, and
determines a route to the destination based on the captured images that have been collected.

2. The navigation device of claim 1, wherein the processor:
collects operation information pertaining to the vehicle, which corresponds to the captured images that have been captured, and
determines a route to the destination based on the captured images and the operation information which have been collected.

3. The navigation device of claim 1, wherein the processor selects locations to avoid, which may impede driving of the vehicle, and determines a route that avoids the locations to avoid.

4. The navigation device of claim 1, wherein the processor selects a recommended location, to which it is recommended to drive the vehicle, and determines a route via the recommended location.

5. A navigation system comprising the navigation device of claim 1 and a plurality of vehicles that are connected by communication to the navigation device.

6. A navigation method, comprising, by a computer:
collecting captured images that have been captured by an imaging device mounted at a vehicle,
setting a destination, and
determining a route to the destination based on the captured images that have been collected.

7. A non-transitory storage medium storing a navigation program that is executable by a computer to perform processing to:
collect captured images that have been captured by an imaging device mounted at a vehicle,
set a destination, and
determine a route to the destination based on the captured images that have been collected.
